(19) United States
(12) Patent Application Publication
(10) Pub. No.: US 2025/0105467 A1
(43) Pub. Date: Mar. 27, 2025

(54) Energy Storage Unit for a Vehicle Driven by an Electric Motor

(71) Applicant: Robert Bosch GmbH, Stuttgart (DE)

(72) Inventors: Dennis Mehlo, Reutlingen (DE); Dennis Ehard, Eningen Unter Achalm (DE); Peter Kunert, Lichtenstein (DE); Simon Buck, St. Johann (DE); Thilo Koeder, Gerlingen (DE)

(21) Appl. No.: 18/821,649

(22) Filed: Aug. 30, 2024

(30) Foreign Application Priority Data
Sep. 21, 2023 (DE) 10 2023 209 212.3

(51) Int. Cl. H01M 50/514; B62J 43/13; B62J 43/28; B62M 6/55; H01M 50/213; H01M 50/249; H01M 50/262; H01M 50/291

(52) U.S. Cl. CPC H01M 50/514; B62J 43/13; B62J 43/28; B62M 6/55; H01M 50/213; H01M 50/249; H01M 50/262; H01M 50/291; H01M 2220/20

(57) ABSTRACT

An energy storage unit for a vehicle driven by an electric motor, in particular for a one-wheeler or two-wheeler driven by an electric motor, has a sub-housing, in which at least two cell stacks are housed for receiving at least two electrochemical energy storage cells in each case, which are configured as round cells. Each energy storage cell comprises two electrical cell poles and the electrical cell poles of at least two energy storage cells are electrically conductively connected to each other in a series and/or parallel connection via at least one cell connector. The at least two cell stacks are arranged adjacent to each other, such that a compression device of the energy storage unit connects the cell connectors to the electrical cell poles of the energy storage cells in the assembled state of the energy storage unit in a non-positive force-fit manner.

This application claims priority under 35 U.S.C. § 119 to patent application no. DE 10 2023 209 212.3, filed on Sep. 21, 2023 in Germany, the disclosure of which is incorporated herein by reference in its entirety.

The disclosure relates to an energy storage unit for a vehicle driven by an electric motor, in particular for a one-wheeler or two-wheeler driven by an electric motor, and to a vehicle driven by an electric motor having an electrochemical energy storage unit which is releasably connectable to the vehicle driven by an electric motor or is fixedly integrated in the vehicle driven by an electric motor according to the genus of the subordinate claims

### BACKGROUND

A large number of vehicles driven by an electric motor are operated with rechargeable energy storage units, which are discharged by the vehicle driven by an electric motor and can be recharged using a charger. Such energy storage units comprise a plurality of electrochemical energy storage cells interconnected in series and/or parallel in order to achieve a required battery voltage or capacity. A particularly advantageous and quite high power and energy density can be achieved if the energy storage cells are designed as, e.g., lithium-ion cells (Li-ion). Typically, such an energy storage unit has an outer housing in which at least two so-called cell stacks are housed for receiving at least two energy storage cells each configured as round cells. Each energy storage cell has two electrical cell poles, wherein the electrical cell poles of at least two energy storage cells are electrically connected to each other via at least one cell connector to achieve the series and/or paralleling circuit.

A rechargeable energy storage unit for a vehicle driven by an electric motor is known from WO 2021/048028 A1, in which a plurality of electrochemical energy storage cells configured as round cells are electrically connected via two cell connector devices arranged at the face ends of the round cells. The cell connector devices are configured as circuit boards having openings and spring-elastic contact elements arranged therein that are connectable to the cell poles of the round cells in a force-fit manner. A plurality of threaded rods is provided to ensure the force-fit connection between the cell poles and the contact elements, which penetrate the two printed circuit boards and fix with nuts screwed on both sides. Alternatively, the fixation of the cell connector devices takes place via protrusions arranged in the outer housing of the energy storage unit.

A rechargeable energy storage unit for a vehicle driven by an electric motor is known from DE 10 2021 206 819 A1, in which a plurality of electrochemical energy storage cells configured as round cells are electrically connected in a series and/or parallel circuit for each cell stack via two cell connector devices arranged at the face ends of the round cells. The electrical connection between the cell connectors and the round cells is such that the cell poles of the energy storage cells each have a material-locking weld connection with at least one contact element of the cell connector. On the one hand, a material-locking connection provides a very secure and permanent electrical contact, but on the other hand it makes it more difficult to remove or replace individual energy storage cells whose maximum capacity has decreased sharply over time or that are defective. Disposal of an energy storage unit to be recycled is also made more difficult by the fact that the individual energy storage cells can only be separated from the cell connectors with relatively large effort.

It is the object of the disclosure to provide an improved energy storage unit compared to the prior art, which enables a simplified replacement of energy storage cells, in particular by service personnel in conjunction with safe operation and a more flexible adaptability of the cell connector device to the required battery voltage or capacity of the energy storage unit.

### SUMMARY

To solve the problem, it is provided that the at least two cell stacks of the energy storage unit are arranged adjacent to each other, such that a compression device of the energy storage unit connects the cell connectors to the electrical cell poles of the energy storage cells in the assembled state of the energy storage unit in a non-positive force-fit manner, wherein a tensile force of the compression device can be adjusted outside a sub-housing. In particular, a sub-housing is to be understood as a partial housing that holds the individual cell stacks together and is arranged in the outer housing of the energy storage unit. With particular advantage, the disclosure allows for a simplified replacement of individual energy storage cells whose maximum capacity has greatly decreased over time or which are defective. Moreover, tolerance compensation in the length extension of the energy storage cells can be carried out in a simple manner such that the force-fit connection between the cell poles and the cell connector is adjustable by the compression device.

For example, the vehicle driven by an electric motor may be configured as an electric bicycle (e.g., EPAC—Electrically Power Assisted Cycle, e-bike, pedelec, e-cargo bicycle, etc.), an electric motorbike, a one- or two-wheeled e-scooter, an e-moped, or the like. The disclosure is also applicable to other applications in the field of micro-mobility applications such as e-kick scooters, mono-wheels, or other non-type-approved vehicles with fixed or interchangeable battery packs installed in the vehicle. A vehicle driven by an electric motor is therefore also to be understood as a vehicle that comprises a drive unit to assist the driver or an electromotive partial drive.

The energy storage unit can be fixedly integrated in the vehicle driven by the electric motor or can be configured as a tool-free, exchangeable battery pack. In the case of an exchangeable battery pack, it may also be provided that it can be charged in the state connected to the vehicle driven by the electric motor and in the state disconnected from the electric vehicle. The battery voltage of the energy storage unit is usually a multiple of the voltage of a single energy storage cell of the energy storage unit and results from the interconnection (parallel and/or series) of the individual energy storage cells. Preferably, the energy storage cells are designed as lithium-based energy storage cells, e.g., Li-ion, Li-polymer, Li-metal, Na-ion, or the like. However, the disclosure can also be applied to energy storage cells having Ni—Cd cells, Ni-Mh cells, or other suitable cell types. For common Li-Ion energy storage cells with a cell voltage of 3.6 V, nominal battery voltages of 3.6 V, 18 V, 36 V, 54 V, etc. result by way of example. However, the disclosure does not depend on the type and design of the energy storage cells used and the energy storage unit, but can be applied to any electrochemical energy storage units and energy storage cells, e.g., in addition to round cells also pouch cells or the like, with battery voltages of 36 V, 48 V, 52 V, or the like.

A further embodiment of the disclosure provides that the compression device is configured as at least one rod projecting through the sub-housing with at least one threaded portion attached on the end face, and for the tensile force to be adjustable via a nut that can be screwed onto the threaded portion. Advantageously, the tensile force of the compression device can be changed very easily and reproducibly in order to ensure a reliable electrical contact between the cell poles of the energy storage cells and the cell connectors over a long period of operation of the energy storage unit on the one hand, and to enable simple replacement of individual energy storage cells on the other. The nuts may be designed with particular advantage as self-locking nuts.

The energy storage unit comprises at least one cell connector device having a carrier layer, wherein the at least one cell connector is arranged on the carrier layer, such that the compression device presses at least one of the electrical cell poles of an energy storage cell in the assembled state of the energy storage unit against a spring elastic contact element of the cell connector in the direction of the carrier layer.

In a further development, the cell connector device is arranged between two cell stacks, wherein at least one cell connector is arranged in each case along a longitudinal axis of the energy storage unit on two opposed end faces of the carrier layer, such that the compression device presses the electrical cell poles of two adjacent energy storage cells of the two cell stacks in the assembled state of the energy storage unit in each case against the contact elements of the cell connectors in the direction of the carrier layer. By pre-assembling the cell connector device symmetrically in this way, a parallel or serial connection of the energy storage cells can be easily realized without an additional material-locking connection process. It is further proposed that the at least two cell connectors arranged on the end faces of the carrier layer are designed as a conductor plate that encompasses the carrier layer in order to electrically connect the electrical cell poles of at least a portion of the energy storage cells of the two cell stacks together. Such a conductor plate allows for particularly simple assembly of the cell connector device, as it only has to be pushed along its end faces onto the carrier layer.

To support the effect of the spring-elastic contact elements, the at least one cell connector device comprises at least one elastic spring component, which is arranged between the carrier layer and the at least one contact element of the at least one cell connector, such that the compression device presses at least one of the electrical cell poles of the energy storage cell in the assembled state of the energy storage unit against the at least one contact element in the direction of the carrier layer against a spring force which results from a first spring force of the contact element and a further spring force of the at least one spring component. In this way, any length tolerances of the energy storage cells can be even better compensated for. Furthermore, the spring component may form a defined stop for the corresponding contact element when pressing the energy storage unit through the compression device. In addition, any weakening of the spring elastic effect of the contact elements can be preventively countered.

In order to avoid radial displacement of individual energy storage cells, e.g., if the energy storage unit falls or if the vehicle driven by an electric motor is hit, it is further provided that the spring component, when the energy storage unit is assembled, creates a friction-locking adhesion contact with the energy storage cell in the area of its cell pole.

The spring component may be comprised of an elastomer, in particular a thermoplastic elastomer (TPE), a foam, in particular Poron, and/or a synthetic polymer, in particular a silicon. The carrier layer of the cell connector device is advantageously composed of a polyamide or polypropylene. The cell connector may be made of an electrically conductive metal such as nickel, copper, steel, aluminum, or Hilumin (diffusion-annealed strip steel with an electrolytic nickel coating).

A further embodiment of the disclosure provides that each cell stack of the energy storage unit comprises a plurality of hollow cylindrical bores for receiving one energy storage cell each, wherein a longitudinal gap is provided in the bore along the longitudinal axis of the energy storage unit, such that at least one spring-assembled longitudinal web of the bore adjacent the longitudinal gap causes radial fixation of the round cell and an inner diameter of the bore without the longitudinal web is larger than an outer diameter of the round cell respectively received therein. In this way, the individual energy storage cells can be very easily inserted into the cell stack in the direction of their length extension and are secured in the radial direction against displacement relative to the contact element of the cell connector connected to one of their cell poles.

To prevent the cell connector devices and the cell stacks from moving relative to one another, the carrier layer of the cell connector device and the cell stack each have a plurality of positive-locking elements for their mutual mechanical connection. At the same time, the positive-locking elements can be used to achieve a clear assembly of the cell connector devices on the cell stacks in the sense of a Poka-Yoke solution, e.g., to prevent polarity reversal of the energy storage cells during assembly.

To solve the task mentioned above, it may further be provided that the energy storage unit comprises at least one cell connector device having a carrier layer on which the at least one cell connector is arranged, such that at least one of the electrical cell poles of an energy storage cell presses against an electrical contact element of the cell connector in the direction of the carrier layer in the assembled state of the energy storage unit, in order to connect the contact element to the electrical cell pole in a force-fit, in particular a non-positive force-fit manner. This results in the advantage of greater contact reliability compared to the prior art, as the carrier layer forms a defined stop for the contact elements. In addition, the separate design of the carrier layer and cell connector makes it possible to easily adapt the cell connector device to a required battery voltage or capacity of the energy storage unit by means of corresponding modifications to the cell connector.

A further embodiment of the disclosure provides that the carrier layer comprises two opposite end faces and at least one cell connector with at least one contact element is arranged on each end face. The energy storage unit comprises at least two cell stacks along a longitudinal axis for receiving at least two energy storage cells each. The cell connector device is arranged between two adjacent cell stacks, wherein at least one cell connector is arranged in each case on two opposed end faces of the carrier layer, such that the electrical cell poles of two adjacent energy storage cells of the two cell stacks in the assembled state of the energy storage unit in each case presses against the contact elements of the cell connectors in the direction of the carrier layer. By pre-assembling the cell connector device symmetrically in this way, a parallel or serial connection of the energy storage cells can be easily realized without an additional material-locking connection process.

It is further proposed that the at least two cell connectors arranged on the end faces of the carrier layer are designed as a conductor plate that encompasses the carrier layer in order to electrically connect the electrical cell poles of at least a portion of the energy storage cells of the two cell stacks together. Such a conductor plate allows for particularly simple assembly of the cell connector device, as it only has to be pushed along its end faces onto the carrier layer.

In order to solve the initially defined problem, it is further provided that the cell connector comprises at least one primary contact element connected to the cell pole of an energy storage cell in a material-locked manner and that the cell connector has at least one redundant contact element for at least one of the primary contact elements comprises that is not connected to an electrical cell pole of the energy storage cells by a material bond in the original state of the assembled energy storage unit. With particular advantage, the disclosure allows for a simplified removal of energy storage cells whose maximum capacity has greatly decreased over time or which are defective, despite the material connection. To this end, the energy storage cell to be removed can be simply detached from the cell connector along with the primary contact element that is connected thereto in a material-locking manner.

In a further development of the disclosure, it is provided that the at least one redundant contact element is used in a service case for the material-locking connection to an electrical cell pole of a replacement energy storage cell for the energy storage cell connected to the primary contact element. This means that the replacement energy storage cell can be connected to the redundant contact element of the cell connector in a very simple way after the energy storage cell to be replaced has been removed.

The at least one redundant contact element is arranged adjacent to the primary contact element, such that an outer contour of the primary and the at least one redundant contact element does not exceed an outer circumference of the connected energy storage cell. A compact design of the cell connector can thus be realized in a particularly advantageous manner. The at least one redundant contact element is then, for example, only force-locked to the cell pole of the energy storage cell connected to the primary contact element. In addition, the cell connector may remain in the same position in the energy storage unit to replace an energy storage cell.

In an alternative or supplementary configuration, it is provided that the at least one redundant contact element is arranged adjacent the primary contact element, such that it can be moved to the position of the primary contact element by folding it over. In this way, it is particularly advantageous to use the same optimal location on the cell pole for the material-locking connection to the redundant contact element of the cell connector for the replacement energy storage cell. In addition, the cell poles of the energy storage cells may have a small electrical contact area to avoid any leakage currents and short-circuits.

In order to enable the replacement of a plurality of energy storage cells in one work step, the cell connector has a main extension plane, which runs in particular transversely to a longitudinal axis of the energy storage unit, wherein the at least one redundant contact element is arranged adjacent to the primary contact element, such that it can be moved into the position of the primary contact element by moving the cell connector along the main extension plane.

To prevent short-circuits, it is further provided that the at least one redundant contact element is electrically insulated in the original state of the assembled energy storage unit, in particular by means of an insulating foil. In this way, accidental activation of the redundant contact element may also be avoided.

To further simplify the servicing or disposal of the energy storage unit, the primary and/or at least one redundant contact element have a desired predetermined breaking point for mechanical separation from the cell connector. The predetermined breaking point must be designed to withstand a normal load and thus be sufficiently robust against external mechanical influences on the energy storage unit, for example in the event of falls, impacts, or strong vibrations, during its intended life cycle.

Furthermore, the primary and/or the at least one redundant contact element may comprise a guide geometry for separation at the predetermined breaking point. In this way, the separation can be simplified by means of a suitable auxiliary tool, e.g., separating pliers or a lever tool, which is applied to the guide geometry. In addition, the auxiliary geometry can be designed to make a replacement of the energy storage cell or manipulation on the cell connector discernible.

The predetermined breaking point is arranged in the immediate vicinity of a connection point between the primary or at least one redundant contact element and the electrical cell pole. Thus, the geometry of a so-called welding pin of the contact element can be designed to break easily during a specific movement. In particular, the predetermined breaking point can be separated by tension, pressure and/or torsion or a shearing movement. As a result, it remains robust against the above-mentioned normal load. Furthermore, it is contemplated that the weld pin itself is designed to be sensitive to torsion. Thus, it could be separated from the cell pole by simply rotating the energy storage cell to be replaced about its longitudinal axis.

In order to also be able to replace an energy storage cell at the same position in the energy storage unit several times if necessary, the cell connector for the primary contact element comprises at least two redundant contact elements. Furthermore, it may be provided that the cell connector comprises at least one redundant contact element for each primary contact element. Thus, all energy storage cells of the energy storage unit can be replaced in the same way in the case of service.

A further object of the disclosure is then to provide an improved cell connector for an energy storage unit compared to the prior art, which can be used universally for different topologies of energy storage units. To solve the problem, it is provided that the cell connector comprises at least one processing area by means of which the contact elements for the cell poles of at least two different energy storage cells can be mechanically and/or electrically separated from one another. With particular advantage, the disclosure allows the applicability of such a universal cell connector for energy storage units of different voltage ranges and/or energy capacities. The cell connector according to the disclosure is therefore designed to be suitable for a maximum variant of the energy storage unit and can be modified accordingly for variants with lower voltage ranges and/or energy capacities in a simple manner by electromechanical separation of the respective contact elements.

To further simplify the adjustability, the at least one processing area is configured as a predetermined breaking point, in particular a taper and/or a perforation. Additionally or alternatively, the contact elements of the cell connector that are connected to an electrical cell pole of the energy storage cells in a material-locking manner comprise a predetermined breaking point for mechanical separation from the cell connector. The predetermined breaking point must be designed to withstand a normal load and thus be sufficiently robust against external mechanical influences on the energy storage unit, for example in the event of falls, impacts, or strong vibrations, during its intended life cycle. In particular, the predetermined breaking point can be separated by tension, pressure, and/or torsion or a shearing movement. As a result, it remains robust against the above-mentioned normal load.

Furthermore, a guide geometry for separating the at least two contact elements at the predetermined breaking point of the cell connector is provided. In this way, the separation can be simplified by means of a suitable auxiliary tool, e.g., separating pliers or a lever tool, which is applied to the guide geometry. It is also conceivable that the predetermined breaking point itself has a corresponding guide geometry, for example in the form of a particularly designed perforation.

In a further configuration, it is provided that the at least one processing area comprises a marking. As a result, it is advantageously possible to more easily identify and/or process the processing area. It is particularly advantageous for those processing areas that result in an electrically meaningful separation to have the same marking. This makes it easier to process the cell connector based on its maximum variant for the intended use in the energy storage unit.

At least one mechanical indicator is provided on the cell connector, in particular at an edge region of the cell connector, to identify a modification made to the cell connector. This makes it easier to recognize during servicing that the corresponding cell connector is no longer in the original state for the maximum variant of the energy storage unit.

The disclosure also relates to an energy storage unit having a plurality of electromechanical energy storage cells designed as round cells and having at least two cell connectors according to the disclosure for an electrical series and/or parallel connection of at least two of the energy storage cells, wherein the at least two cell connectors are identical in their original state. In so doing, at least one of the at least two cell connectors can be processed prior to final assembly of the energy storage unit, such that at least two contact elements of the machined cell connector are mechanically and/or electrically separated from one another.

### BRIEF DESCRIPTION OF THE DRAWINGS

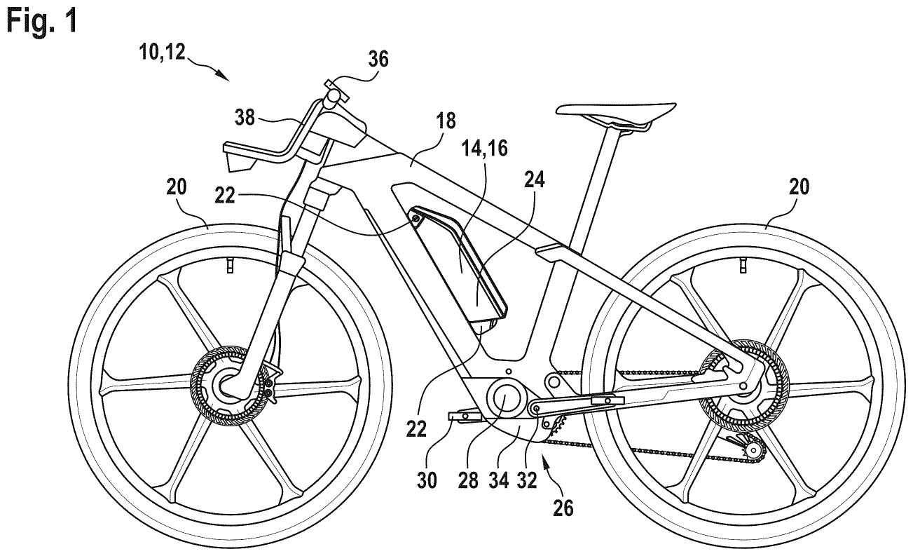

The disclosure is explained below with reference to FIGS. 1 through 20 by way of example, wherein identical reference numbers in the drawings indicate identical components having an identical function.

### Shown are:

FIG. 1 shows a schematic illustration of a vehicle driven by an electric motor configured as a two-wheeled electric bicycle in a first variant,

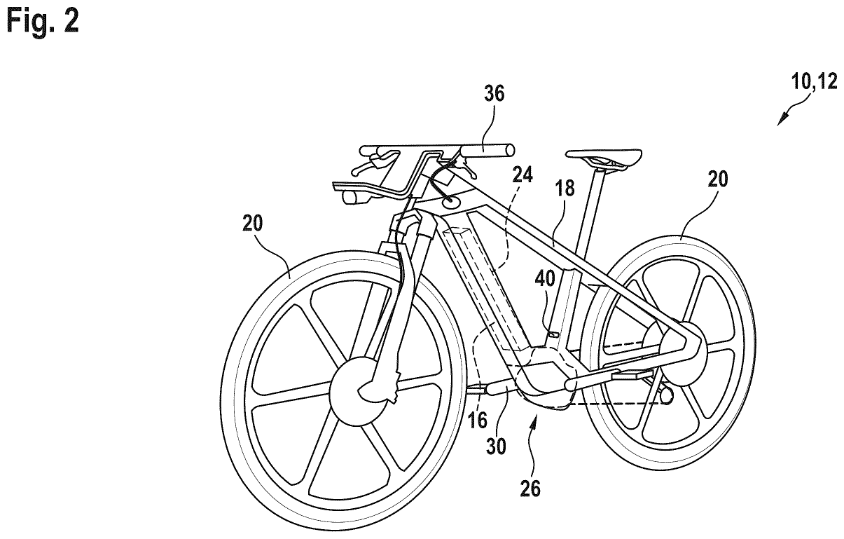

FIG. 2 shows a schematic illustration of the vehicle driven by an electric motor configured as a two-wheeled electric bicycle in a second variant,

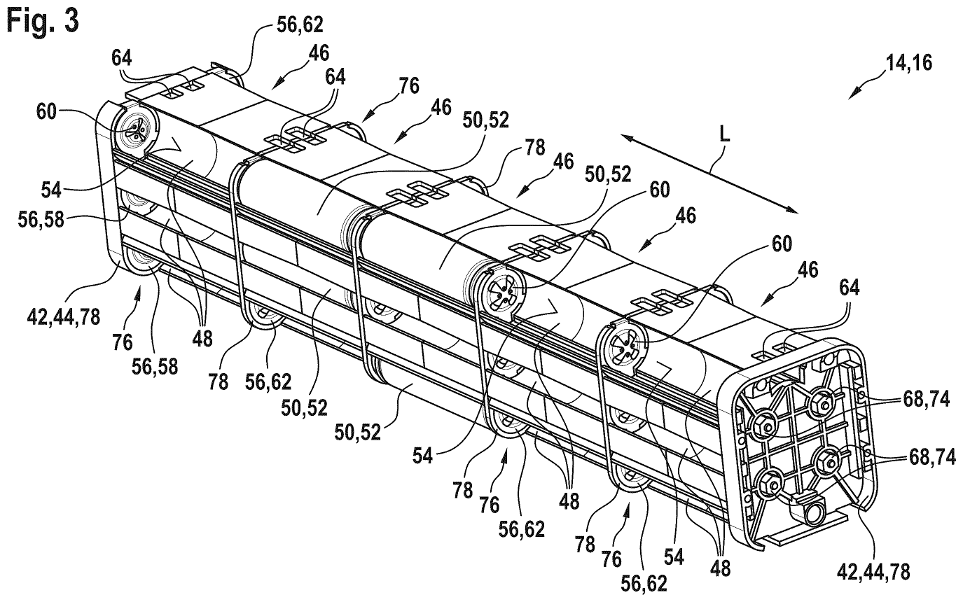

FIG. 3 shows a first exemplary embodiment of an energy storage unit for the vehicle driven by an electric motor according to FIG. 1 or 2 in a perspective view,

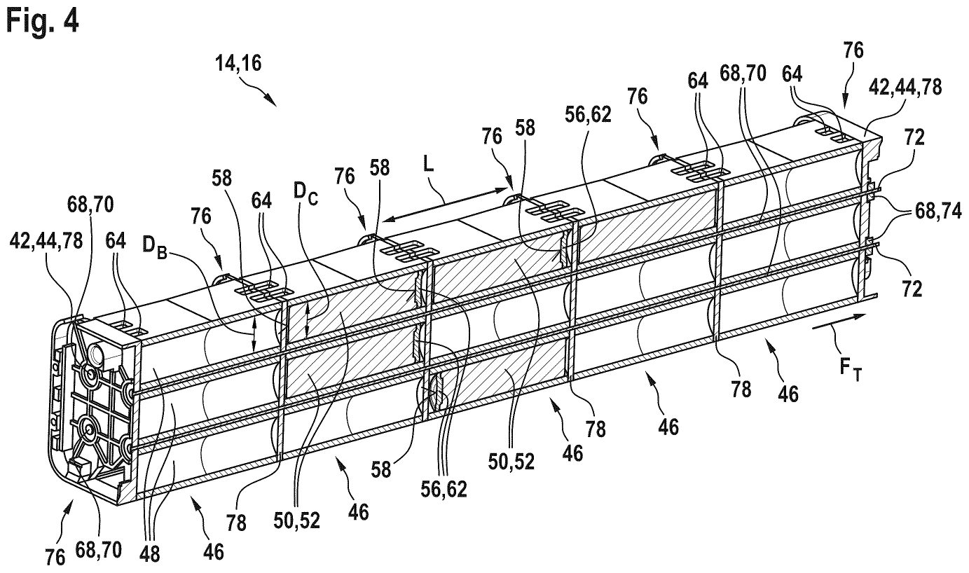

FIG. 4 shows the energy storage unit according to FIG. 3 in a section along its longitudinal axis,

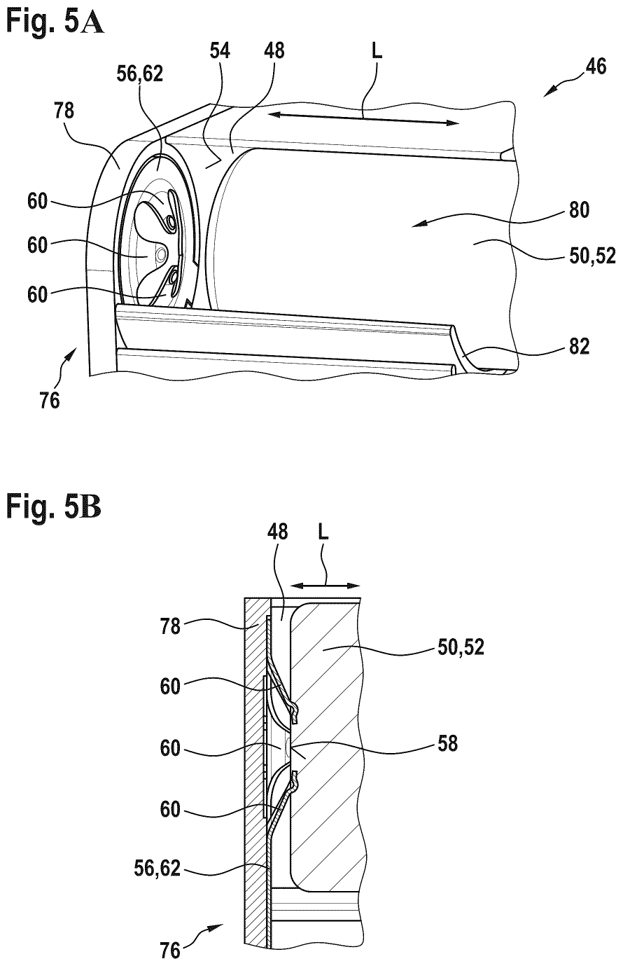

FIG. 5A shows a perspective view of a cell connector device of the energy storage unit according to the exemplary embodiment according to FIGS. 3 and 4,

FIG. 5B shows a sectional view of the cell connector device of the energy storage unit according to the exemplary embodiment according to FIGS. 3 and 4,

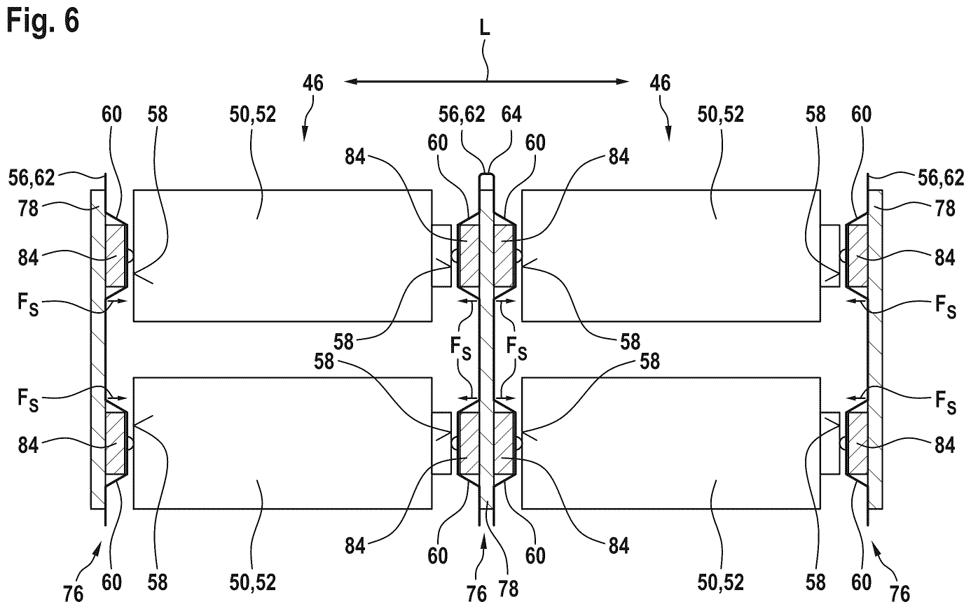

FIG. 6 shows a further exemplary embodiment of the cell connector device in a sectional view along the longitudinal axis of the energy storage unit,

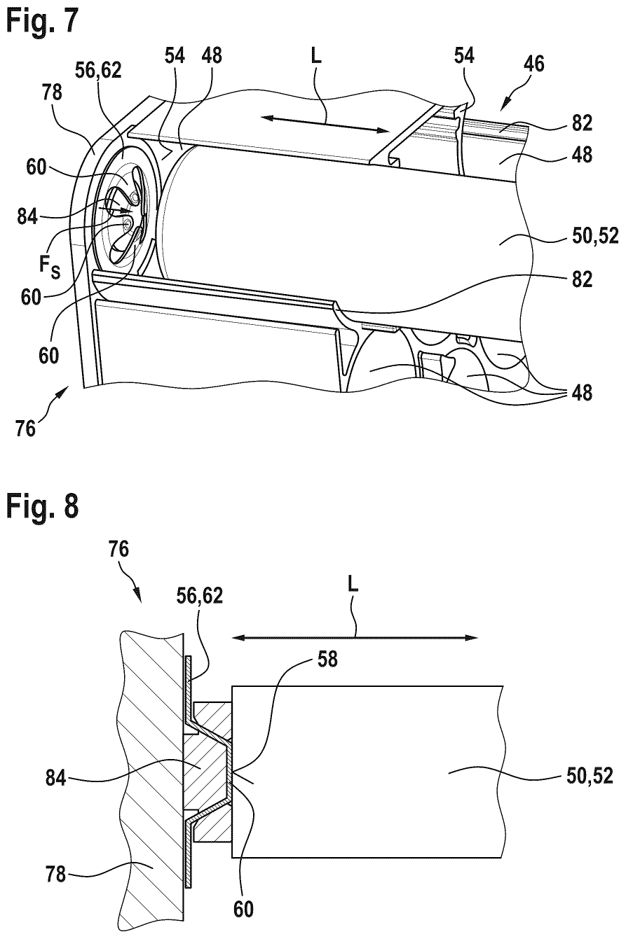

FIG. 7 shows the exemplary embodiment according to FIG. 6 in a perspective view,

FIG. 8 shows a further exemplary embodiment of the cell connector device in a sectional view along the longitudinal axis of the energy storage unit,

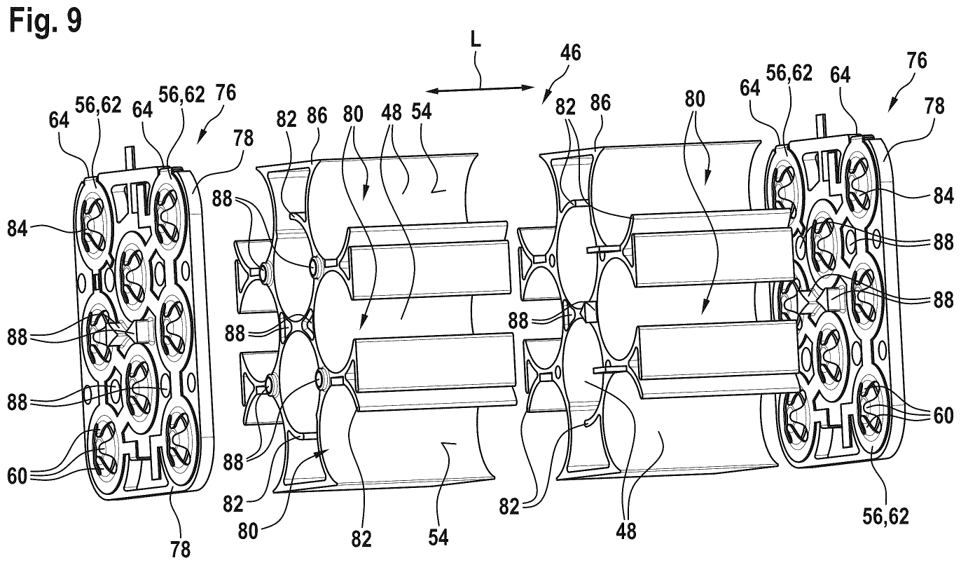

FIG. 9 shows an exploded view of a cell stack of the energy storage unit including two cell connector devices arranged on the end front according to FIG. 6,

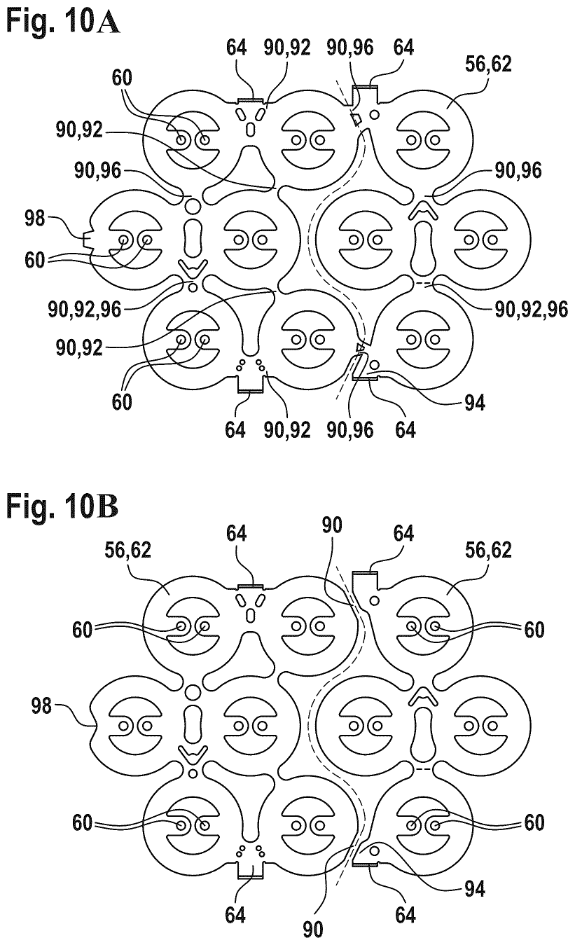

FIG. 10A shows a further exemplary embodiment of a cell connector of the cell connector device configured as a conductor plate before processing,

FIG. 10B shows a further exemplary embodiment of the cell connector of the cell connector device configured as a conductor plate after processing,

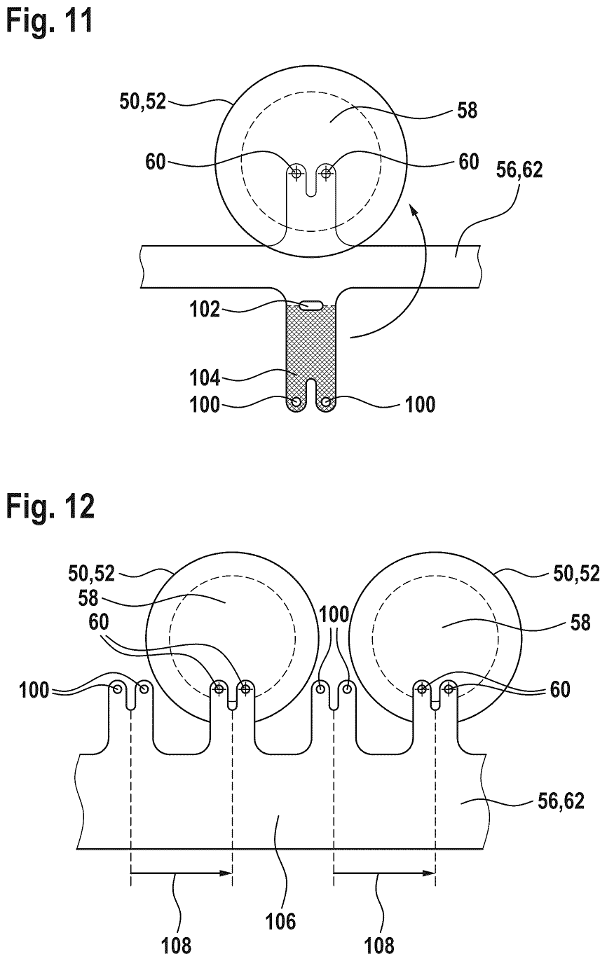

FIG. 11 shows a further exemplary embodiment of the cell connector having two primary and two redundant contact elements for an energy storage cell,

FIG. 12 shows a further exemplary embodiment of the cell connector having two primary and two redundant contact elements for two energy storage cells,

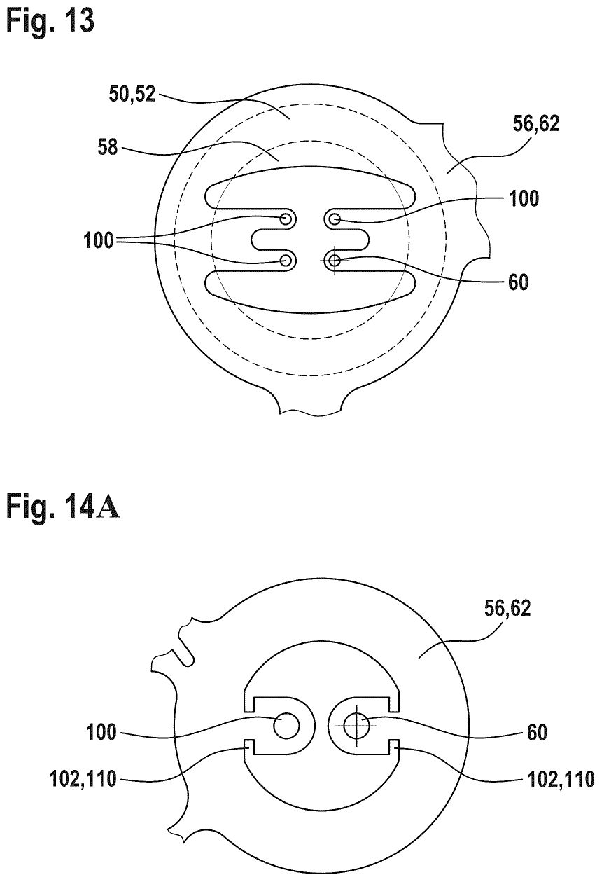

FIG. 13 shows a further exemplary embodiment of the cell connector having a primary and three redundant contact elements for an energy storage cell,

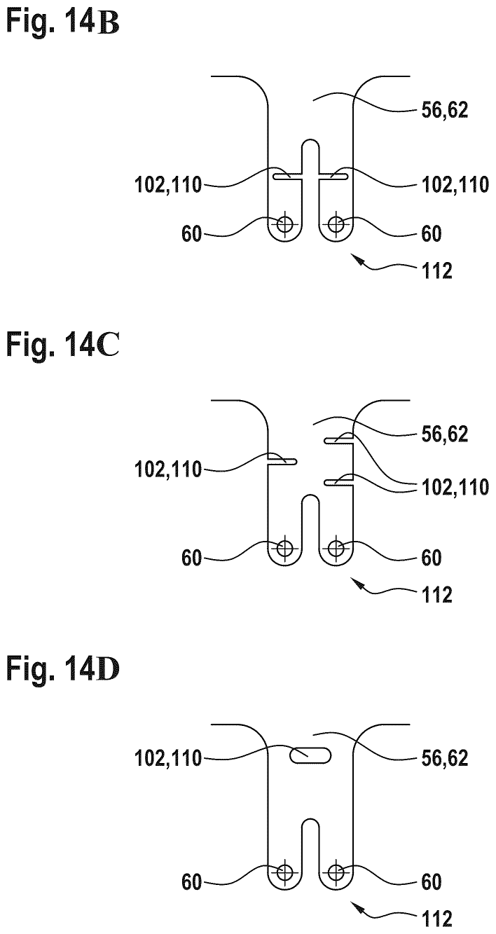

FIG. 14A shows a further exemplary embodiment of the cell connector with at least one processing area for the primary and redundant contact elements,

FIG. 14B shows a further exemplary embodiment of the cell connector with a different configuration of the processing area for two primary contact elements,

FIG. 14C shows a further exemplary embodiment of the cell connector with a different configuration of the processing area for two primary contact elements,

FIG. 14D shows a further exemplary embodiment of the cell connector with a different configuration of the processing area for two primary contact elements,

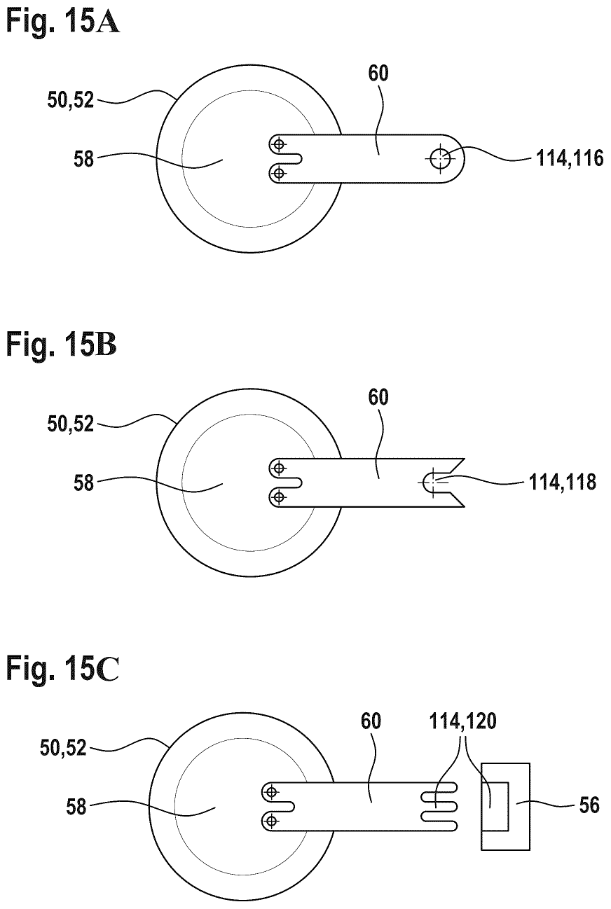

FIG. 15A shows an exemplary embodiment for a releasable connection of a contact element on the cell connector as a closed eyelet,

FIG. 15B shows an exemplary embodiment for a releasable connection of a contact element on the cell connector as a single-sided open eyelet,

FIG. 15C shows an exemplary embodiment for a releasable connection of a contact element on the cell connector as a plug-in connection,

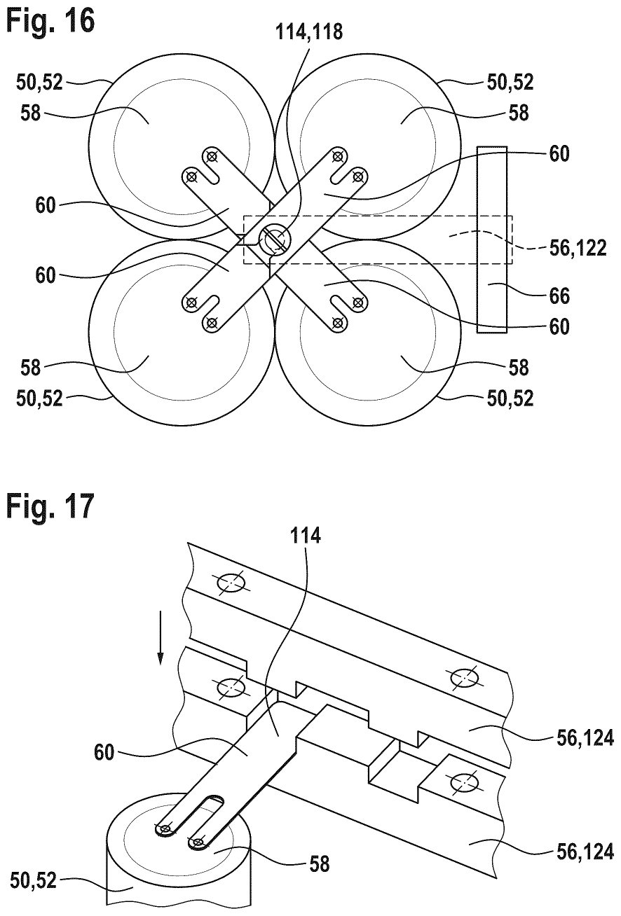

FIG. 16 shows an exemplary embodiment of a releasable connection of four contact elements on a cell connector by means of a single screw connection,

FIG. 17 shows an exemplary embodiment of a releasable connection of a contact element with a cell connector configured as a rail system,

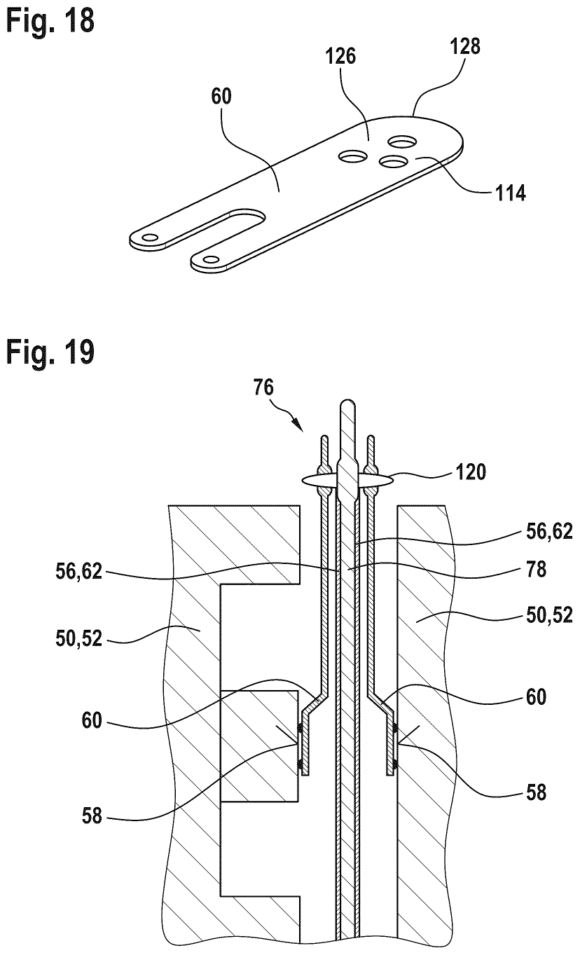

FIG. 18 shows a further exemplary embodiment of a releasable connection of a contact element with the cell connector configured as a rail system,

FIG. 19 shows a sectional view of the reversible plug-in connection according to FIG. 15C for a cell connector device with a cell connector arranged on both sides, and

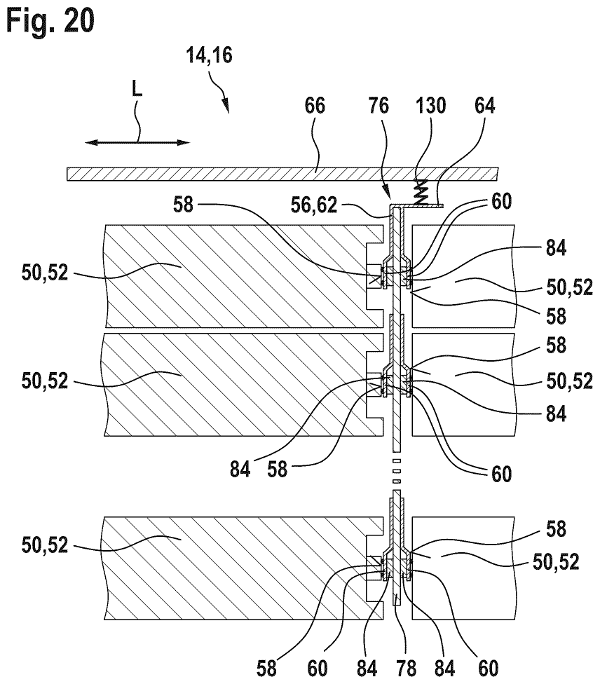

FIG. 20 shows an exemplary embodiment of a reversible connection between the cell connector device or the cell connector and a printed circuit board of the energy storage unit.

### DETAILED DESCRIPTION

FIG. 1 shows a schematic illustration of a vehicle driven by an electric motor 10 configured as a two-wheeled electric bicycle 12. The electric bicycle 12 is powered by an energy storage unit 16 configured as an exchangeable battery pack 14 and may be configured as, for example, a pedelec, an e-bike, or the like. The electric bicycle 12 has a housing in the form of a frame 18 with two wheels 20 supported in the frame 18. The exchangeable battery pack 14 is releasably connected via a connection device 22 provided on the frame 18, which electro-mechanically cooperates with an interface (not shown in more detail) attached to an outer housing 24 of the exchangeable battery pack 14.

The electric bicycle 12 further comprises a drive unit 26, which comprises an electric motor 28, preferably in the form of an EC or BLDC motor, in the form of a center motor. Alternatively, a hub motor may also be used in one of the wheels 20 instead of a center motor. The drive unit 26 is also powered by the exchangeable battery pack 14 and comprises an electronic unit (not shown) for controlling or regulating the electric bicycle 12, in particular the electric motor 28. The electronic unit is further connected to a sensor unit (also not shown), which comprises, e.g., multiple sensor elements, such as a torque sensor, a motion sensor, e.g., in the form of an acceleration sensor, and a magnetic sensor. A pedal crank 30 with a pedal crankshaft 32 is further provided on the electric cycle 12, via which the rider can perform a pedaling movement to drive the rear wheel 20 in the manner of a conventional bicycle drive. The electronic unit, the drive unit 26 having the electric motor 28 and the pedal crankshaft 32 are arranged within a drive housing 34 connected to the frame 18.

The drive movement of the electric motor 28 is preferably transmitted to the pedal crankshaft 32 via a transmission (not shown), wherein the intensity of the assistance by the drive unit 26 is controlled or regulated via the electronic unit. The electronic unit is designed to control the drive unit 26 such that the rider of the electric bicycle 12 is assisted in pedaling. Preferably, the electronic unit is designed such that it can be operated by the rider so that the rider can set the assistance level.

The electric bike 12 also comprises an on-board computer 36 arranged on a handlebar 38 of the electric bike 12. The on-board computer 36 is, by way of example, releasably configured with the electric bicycle 12 and includes a human machine interface (HMI) that is used to display information and control the on-board computer 36 and/or the electric bicycle 12 and the drive unit 26. The HMI is exemplary configured as a touch screen or the like. The on-board computer 36 is connected to the drive unit 26 for exchanging information and commands. For example, the HMI can be used to display a speed determined by the electronic unit of the drive unit 26 by means of the sensor unit, a set level of assistance of the electric motor 28, route information from a navigation unit integrated in the on-board computer 36, a charge status of the exchangeable battery pack 14, or the like.

FIG. 2 shows an alternative of the electric bicycle 12. In contrast to FIG. 1, the energy storage unit 16 including its electromechanical interfaces for energy and/or data transmission between the electric bicycle 12 and the energy storage unit 16 is completely integrated in the frame 18 of the electric cycle 12. However, for easier replacement of the energy storage unit 16, it still has an outer housing 24. In addition, a charging and/or discharging interface 40 for charging and/or discharging the energy storage unit 16 is provided in the frame 18 of the electric bicycle 12, accessible from the outside. This is configured as a USB-C interface, by way of example. However, other interfaces to wired or wireless power and/or data transmission are also contemplated. In addition, a plurality of such interfaces 40 may also be provided on the electric bicycle 12.

In FIGS. 3 and 4, an exemplary embodiment of the interior of the energy storage unit 16 is shown in a perspective view or in a section along a longitudinal axis L of the energy storage unit 16. A sub-housing 44 consisting of at least two face end caps 42 is provided in the outer housing 24 (not shown) of the energy storage unit 16. The energy storage unit 16 consists, by way of example, of five cell stacks 46 which are arranged along the longitudinal axis L of the energy storage unit 16 with their end faces adjacent to each other. The arrangement of the cell stacks 46 with respect to each other determines the elongated geometry of the energy storage unit 16.

By way of example, each cell stack 46 has a total of eight hollow cylindrical bores 48 for receiving an energy storage cell 52 configured as a round cell 50. Each hollow cylindrical bore 48 itself has a cylindrical wall 54 that encloses the round cell 50 along its lateral surface. The bores 48 each have a radial central axis that substantially corresponds to a radial central axis of the round cells 50 and which runs parallel to the longitudinal axis L of the energy storage unit 16. The walls 54 of cell stack 46 are configured to be associated with two different bores 48 between two radially adjacent round cells 50. To make it easier to push the round cells 50 along the longitudinal axis L of the energy storage unit 16 into the bores 48 or to push them out again accordingly in the case of service, an inner diameter DB of each bore 48 is minimally larger than an outer diameter Dc of the respective round cell 50 accommodated therein. The walls 54 or cell stack 46 are preferably formed integrally from a thermoplastic or a comparable material. In FIGS. 3 and 4, only individual bores 48 are filled with round cells 50 for clarity. A fully assembled energy storage unit 16 is typically fully occupied with energy storage cells 52.

The plurality of a total of 40 round cells 50 is connected via cell connectors 56 in a series circuit and/or in a parallel circuit, wherein the series circuit defines a battery voltage U_{Batt} dropping across the electromechanical interface (not shown) of the energy storage unit 16, while the parallel connection of individual round cells 50 primarily increases the capacity of the energy storage unit 16. The cell connectors 56 are made of an electrically conductive metal, such as nickel, copper, steel, aluminum, or Hilumin. On their two end faces, each round cell 50 has a positive or a negative electrical cell pole 58 for electromechanical contacting with at least one spring-elastic contact element 60 of the cell connector 56 configured as a conductor plate 62. The contact elements 60 thus extend substantially parallel to the cell poles 58 of the round cells 50, wherein the cell poles 58 are oriented substantially perpendicular to the longitudinal axis L of the energy storage unit 16. In this context, “substantially” should be understood to mean that there need not be a precisely parallel or perpendicular curve, but that this can also deviate slightly due to tolerance. Each contact element 60 in turn allows for a non-positive, friction-locked connection of the cell connector 56 to the respective cell pole 58 of the round cell 50. However, instead of a purely friction-locking connection, a material-locking connection between the cell pole 58 and the contact element 60, for example in the form of a resistance, ultrasonic or laser weld joint, is also contemplated. A soldered connection would also be possible, wherein the possibly increased heat input into the energy storage cell must be observed here. Furthermore, the cell connectors 56, in conjunction with a microprocessor (not shown in more detail) of an electronic unit of the energy storage unit 16, are used for single cell monitoring (SCM). For this purpose, the cell connectors 56 are connected to a printed circuit board 66 via electrical contacts 64, in particular via contact tabs of the printed circuit board 62 (cf. FIG. 20), on which the electronic unit is arranged together with the microprocessor. Since neither the electronic unit nor the microprocessor and their arrangement on a corresponding printed circuit board within the energy storage unit 16 are of importance for the disclosure, this will not be discussed further. The person skilled in the art is familiar with corresponding devices for monitoring or controlling or regulating the energy storage cells 52.

In common Li-Ion round cells 50 having a nominal cell voltage U_{Cell} of 3.6 V each, battery voltages U_{Batt} of n 3.6 V drop across corresponding electrical contacts of the electromechanical interface, where n defines the number of round cells 50 connected in series. So-called cell clusters consisting of round cells 50 connected in parallel may also be connected in series via the cell connectors 56 in order to achieve a specific particular battery voltage U_{Batt} with simultaneously increasing capacity. For other electrochemical energy storage cells 52, the nominal cell voltage U_{Cell} may deviate, so that battery voltages of 18 V to 70 V and more are possible depending on the type and application case of the energy storage unit 16. Depending on the number of energy storage cells 52 connected in parallel in a cell cluster, the capacity of commercially available high-performance energy storage units 16 can be up to 14 Ah and more, such that, for example, up to 750 Wh can be achieved in the e-bike range. However, the disclosure is not dependent on the type, design, voltage, power supply capability, etc. of the energy storage cells 52 used, but can be used for a plurality of different energy storage units 16.

FIG. 4 illustrates that the five cell stacks 46 of the energy storage unit 16 are arranged adjacent to one another along the longitudinal axis L, such that a compression device 68 connects the cell connectors 56 with the electrical cell poles 58 of the round cells 50 in the assembled state of the energy storage unit 16 in a non-positive force-fit manner. Since the round cells 50 do not always have exactly the same length extension during production, this makes it very easy to compensate for tolerances in conjunction with the spring-elastic contact elements 60 of the cell connectors 56. The compression device 68 in the exemplary embodiment shown consists of four rods 70 penetrating the sub-housing 44 and the cell stacks 46 having a threaded portion 72 at least at one end. A tensile force Fr acting on the sub-housing 44, cell stacks 46, and cell connectors 56 may thus be easily adjusted outside the sub-housing 44 via a nut 74 of the compression device 68, which can be screwed onto the threaded portion 72, in order to ensure a reliable electrical contact between the cell poles 58 of the round cells 50 and the cell connectors 56 over a long operating period of the energy storage unit 16. In addition, it is also possible to disassemble the energy storage unit 16 in order to replace individual round cells 50 whose maximum capacity has greatly decreased over time or which are defective. The nuts may be designed with particular advantage as self-locking nuts.

The cell connectors 56 arranged at the end faces of the cell stacks 46 are each part of a cell connector device 76. The cell connector devices 76 are arranged both between the cell stacks 46 and on the outer two end faces of the structural unit comprising the cell stacks 46, so that the two end caps 42 of the sub-housing 44 also each form a cell connector device 76. With reference to FIGS. 5A (perspective view) and 5B (sectional view), each cell connector device 76 has a carrier layer 78 on which the cell connector 56 in the form of a conductor plate 62 with its spring-elastic contact elements 60 is arranged. For example, the carrier layer 78 can be composed of a polyamide, polypropylene, or comparable material with corresponding electrically insulating properties. Likewise, a carrier layer 78 made of an epoxy resin or the like is also contemplated. To illustrate the structure of the cell connector device 76, the round cell 50 in FIG. 5A is not fully inserted into the bore 48. FIG. 5B shows the inserted state of the round cells 50 in an enlarged section at its cell pole 58. The compression device 68 presses the electrical cell pole 58 in the assembled state of the energy storage unit 16 against the spring-elastic contact elements 60 of the cell connector 56 in the direction of the carrier layer 78. As the carrier layer 78 forms a defined stop for the contact elements 60, there is the advantage of a high contact reliability between the cell poles 58 and the contact elements 60. In addition, the separate design of the carrier layer 78 and cell connector 56 makes it possible to easily adapt the cell connector device 76 to a required battery voltage or capacity of the energy storage unit 16 by means of corresponding modifications to the cell connector 56.

Along the longitudinal axis L of the energy storage unit 16, a longitudinal gap 80 is provided in the bore 48 of the cell stack 46, such that that at least one spring-mounted longitudinal web 82 of the bore 48 adjacent to the longitudinal gap 80 effects a radial fixation of the round cell 50 by reducing the inner diameter DB of the bore 48 relative to the outer diameter Dc of the round cell 50. In this way, a backlash-free fixation of the round cell 50 in the bore 48 can be realized in conjunction with an easy insertion or extraction in the axial direction along the longitudinal axis L. The longitudinal web 82 is preferably integrally formed with the wall 54 of the bore 46. However, it is also contemplated that longitudinal web 82 may be connected to wall 54 by means of an adhesive connection, or the like.

FIG. 6 shows a highly simplified sectional view along the longitudinal axis L of a further embodiment of the energy storage unit 16 with two adjacent cell stacks 46 and round cells 50 inserted therein. In the middle of the three cell connector devices 76, at least one cell connector 56 is arranged on each of the two opposite end faces of the carrier layer 78 along the longitudinal axis L, such that the compression device 68 (not shown) presses the electrical cell poles 58 of the round cells 50 of the two cell stacks 46, which are adjacent along the longitudinal axis L, against the contact elements 60 of the cell connectors 56 in the direction of the carrier layer 78 in the assembled state of the energy storage unit 16. It is proposed that the two cell connectors 56 arranged on each end face of the carrier layer 78 are each designed as an integral conductor plate 62 that encompasses the carrier layer 78 at one edge, in order to electrically connect the electrical cell poles 58 of the round cells 50 of the two adjacent cell stacks 46 together. Accordingly, the cell connectors 56 or the conductor plate 62 and carrier layer 78 have a sandwich construction. The encompassment of the carrier layer 78 can in particular be realized by the electrical contacts 64 for connection to the printed circuit board 66. Such a conductor plate 62 also allows for particularly simple assembly of the cell connector device 76, as it only has to be pushed along its end faces onto the carrier layer 78. By pre-assembling the cell connector device 76 symmetrically in this way, a parallel or serial connection of the round cells 50 can be easily realized without an additional material-locking connection process.

To support the effect of the spring-elastic contact elements 60, the cell connector device 76 comprises at least one elastic spring component 84, which is arranged between the carrier layer 78 and the contact elements 60 of the cell connector 56, such that the electrical cell pole 58 of the round cell 50 is pressed against the contact elements 60 in the direction of the carrier layer 78 against a spring force Fs in the assembled state of the energy storage unit 16, in particular by the compression device 68, which results from a first spring force of the contact element 60 and a further spring force of the at least one spring component 84. FIG. 7 illustrates this in a view analogous to FIG. 5A with the round cell 50 that has not yet been fully inserted. In this way, any length tolerances of the round cells 50 can be even better compensated for. Furthermore, the spring component 84 may form a defined stop for the corresponding contact element 60 when pressing the energy storage unit 16. In addition, any weakening of the spring elastic effect of the contact elements 60 can be preventively countered. Preferably, the spring component 84 is manufactured from an elastomer, in particular a thermoplastic elastomer (TPE), a foam, in particular Poron, and/or a synthetic polymer, in particular silicon. In other words, composites made from the aforementioned materials are also conceivable.

In FIG. 8, a further embodiment of the energy storage unit 16 or the cell connector device 76 is shown in a section along the longitudinal axis L of the energy storage unit 16. In order to avoid radial displacement of the round cells 50, e.g., if the energy storage unit 16 falls or if the vehicle 10 driven by an electric motor is hit, it is provided that the spring component 84, in the assembled state of the energy storage unit 16, creates a friction-locking adhesion contact with the round cell 50 cell in the area of its cell pole 58.

FIG. 9 shows an exploded view of the cell stack 46. This consists of two cell holders 86, whose cylindrical walls 54 form a lattice structure for the total of eight hollow cylindrical bores 48. In addition, as already described in FIG. 6, each bore 48 has a longitudinal gap 80 along the longitudinal axis L of the energy storage unit 16 and at least one spring mounted longitudinal web 82. A cell connector device 76 for electrically connecting the round cells 50 (not shown) inserted in the bores 48 is arranged on each end face of the cell stack 46 composed of the two cell holders 86. Each cell connector device 76 has two cell connectors 56, designed as integral conductor plates 62, that encompass the carrier layer 78 at one edge in order to electrically connect the electrical cell poles 58 of the round cells 50 of two adjacent cell stacks 46 in a series and/or parallel connection. The two conductor plates panels 62 and the carrier layer 78 are thus realized in a sandwich construction. To prevent the cell connector devices 76 and the cell holders 86 of the cell stacks 46 from moving relative to one another, the carrier layer 78 of the cell connector device 76 and the cell holders 86 each have a plurality of positive-locking elements 88 for their mutual mechanical connection. The positive-locking elements 88 may be configured in a very different manner, for example, triangular, pin-shaped, and/or circular protrusions that engage with corresponding complementary indentations of the parts to be joined. The positive-locking elements 88 also enable the cell connector devices 76 to be clearly mounted on the cell stacks 46 or the cell holders 86 in the sense of a Poka-Yoke solution, in particular to prevent polarity reversal of the round cells 50 used during assembly of the energy storage unit 16. It should be noted that a cell stack 46 may also be configured as a single cell holder 86, or a cell holder 86 may then, in its operation, correspond to a cell stack 46.

FIGS. 10A and 10B show a further exemplary embodiment of the cell connector 56 configured as a conductor plate 62 for a cell stack 46 with a total of 10 energy storage cells 52 in a top plan view. The cell connector 56 has a plurality of processing areas 90, by means of which the contact elements 60 to be connected for the cell poles 58 of different energy storage cells 52 can be mechanically and/or electrically separated from one another. Thus, a universal cell connector 56 may be provided for energy storage units 16 of different voltage ranges and/or energy capacities. The cell connector 56 according to FIG. 10A is designed to be suitable for a maximum variant of the energy storage unit 16 and can be modified in a simple manner accordingly for variants with lower voltage ranges and/or energy capacities by electromechanical separation of the respective contact elements by means of the processing areas 90. To further simplify the adjustability, the processing area 90 is configured as a predetermined breaking point 92, for example in the form of a taper and/or a perforation. The predetermined breaking point 92 must be designed to withstand a normal load and thus be sufficiently robust against external mechanical influences on the energy storage unit 16, for example in the event of falls, impacts, or strong vibrations, during its intended life cycle. In particular, the predetermined breaking point 92 can be separated by tension, pressure, and/or torsion or a shearing movement. As a result, it remains robust against the above-mentioned normal load.

In order to simplify the separation at the processing area 90 of the cell connector 56 by means of a suitable auxiliary tool, e.g., separating pliers or a lever tool, the cell connector 56 has a guide geometry 94 in the vicinity of the machining area 90 to which the auxiliary tool can be applied. It is also conceivable that the predetermined breaking point 92 itself has a corresponding guide geometry 94, for example in the form of a particularly designed perforation.

Easier identification and/or processing of the machining area 90 is further achieved when it has a marking 96. The markings 96 may be designed such that the machining areas 90 resulting in electrically meaningful separation have an identically designed marking 96. This makes it easier to process the cell connector 56 based on its maximum variant for the intended use in the energy storage unit 16.

In FIG. 10B shows an exemplary separation of the cell connector 56 of FIG. 10A into two separate conductor plates 62 at the dashed line. To this end, two of the total nine processing areas 90 were separated by means of a suitable cutting tool at the corresponding markings 96 or with the aid of the guide geometry 96 according to FIG. 10A. The two conductor panels 62 may thus form two cell clusters within the cell stack 46 via their contact elements 60, which are still electromechanically connected to one another. Depending on the orientation of the energy storage cells 52 in the associated bores 48 of the cell stack 46, a parallel or series connection may thus be implemented for the corresponding cell cluster. In addition, it is possible to connect the energy storage cells 52 of adjacent cell stacks 46 in a parallel and/or series connection according to the requirements for the energy storage unit 16 by means of a conductor plate 62, which is arranged on both sides of the carrier layer 78 of the cell connector device 76, the contact elements 60 of which are electro-mechanically connected to each other via the contact 64.

A mechanical indicator 98 is provided on the cell connector 56, in particular at an edge region of the cell connector 56, to identify a modification made to the cell connector 56. After processing the cell connector 56 in FIG. 10B, the protrusion recognizable in FIG. 10A was removed by means of a separating tool. This makes it easier to recognize during servicing that the corresponding cell connector is no longer in the original state for the maximum variant of the energy storage unit 16.

In contrast to a non-positive force-fit connection of the contact elements 60 and the cell poles 58, their positive connection provides a very secure and permanent electrical contact, but on the other hand it makes it more difficult to remove or replace individual energy storage cells 52 whose maximum capacity has decreased sharply over time or that are defective. Disposal of an energy storage unit 16 to be recycled is also made more difficult by the fact that the individual energy storage cells 52 can only be separated from the cell connectors 56 with relatively large effort. FIGS. 11 to 13 and 14A, 14B, 14C, and 14D therefore propose solutions such that the cell connector 56 comprises at least one primary contact element 60 connected to the cell pole 58 of an energy storage cell 52 in a material-locked manner, wherein the cell connector 56 has at least one redundant contact element 100 for at least one of the primary contact elements 60 comprises that is not connected to an electrical cell pole 58 of the energy storage cells 16 by a material bond in the original state of the assembled energy storage unit 16. Thus, despite a material-locking connection between cell connector 56 and energy storage cell 52, easy removal of the energy storage cells 52 is possible. To this end, the energy storage cell 52 to be removed can be simply detached from the cell connector 56 along with the primary contact element 60 that is connected thereto in a material-locking manner. The at least one redundant contact element 100 is used in a service case for the material-locking connection to an electrical cell pole 58 of a replacement energy storage cell 52 for the energy storage cell 52 connected to the primary contact element 60. The replacement energy storage cell 52 may be connected to the redundant contact element 100 of the cell connector 56 in a very simple manner, for example by resistance, ultrasonic or laser welding, after the energy storage cell 52 to be replaced has been removed. For clarity, in 11 to 13 and 14A, 14B, 14C, and 14D, the point-type connection points (dimples) of the contact elements 60 welded to a cell pole 58 are marked with a small cross, while the non-welded dimples of the redundant contact elements 100 are shown as an empty circle. A soldered connection is also conceivable in principle, taking into account the heat input into the replacement energy storage cell 52.

In FIG. 11, two redundant contact elements 100 are arranged adjacent to the two primary contact elements 60 that are connected to the cell pole 58 of the energy storage cell 52, such that they can be brought to the position of the primary contact elements 60 by folding them over at a processing area 102 provided for this purpose, which can be designed, for example, as a perforation and/or marking, after the energy storage cell 52 has been replaced by a corresponding replacement energy storage cell 52 and the primary contact elements 60 have been separated. In this way, it is particularly advantageous to use the same optimal location on the cell pole 58 for the material-locking connection to the redundant contact elements 100 of the cell connector 56 for the replacement energy storage cell 52. In addition, cell poles 58 of energy storage cells 52 may have a small electrical contact area, as is particularly the case with cell poles 58 with positive voltage potential, in order to prevent any leakage currents and short-circuits. To prevent short-circuits, it is further provided that the at least one redundant contact element 100 is electrically insulated in the original state of the mounted energy storage unit 16, in particular by means of an insulating foil 104. In this way, accidental activation of the redundant contact element 100 may also be avoided.

In order to enable the replacement of a plurality of energy storage cells 52 in one work step, the cell connector 56 according to FIG. 12 has a main extension plane 106, which is in particular runs transversely to the longitudinal axis L of the energy storage unit 16. The redundant contact elements 100 are arranged adjacent to the primary contact elements 60, such that they can be brought into the position of the primary contact elements 60 by moving the cell connector 56 along the main extension plane 106 (indicated by arrows 108).

According to FIG. 13, the redundant contact elements 100 are arranged adjacent the primary contact element 60, such that an outer contour of the primary and redundant contact elements 60, 100 does not exceed an outer circumference of the energy storage cell 52, which is connected to the primary contact element 60 and configured as a round cell 50. A compact design of the cell connector 56 can thus be realized in a particularly advantageous manner. The redundant contact elements 100 then, for example, only force-locked to the cell pole 58 of the round cell 50, which is connected to the primary contact element 60 in a material-locking manner. In addition, the cell connector 56 can remain unchanged at the same position in the energy storage unit 16 or the cell stack 46 to replace the round cell 50. In order to also be able to replace a round cell 50 at the same position in the energy storage unit 16 several times if necessary, the cell connector 56 for the primary contact element 60 comprises three redundant contact elements 100. Furthermore, it may be provided that the cell connector 56 comprises at least one redundant contact element 100 for each primary contact element 60. Thus, all energy storage cells 52 of the energy storage unit 16 can be replaced in the same way in the case of service.

In order to further simplify the servicing or disposal of the energy storage unit 16, the processing area 102 of the primary and/or the at least one redundant contact element 60, 100 according to FIGS. 14A, 14B, 14C, and 14D is each designed as a predetermined breaking point 110. This allows mechanical separation of the energy storage cell 52 from the cell connector 56 by simple breaking it off, if necessary without any additional tool. The predetermined breaking point 110, however, must be designed to withstand a normal load and thus be sufficiently robust against external mechanical influences on the energy storage unit 16, for example in the event of falls, impacts, or strong vibrations, during its intended life cycle. In particular, the predetermined breaking point 110 can be separated by tension, pressure and/or torsion or a shearing movement. As a result, it remains robust against the above-mentioned normal load.

The predetermined breaking point 110 is arranged in the immediate vicinity of the dimple between the primary or at least one redundant contact element 60, 100 and the electrical cell pole 58 of the energy storage unit 16. Also, the dimple itself may function as the predetermined breaking point 110. The geometry of the dimple is designed to break easily during a specific movement, and is in particular sensitive to torsion. Thus, the dimple could be separated from the cell pole 58 by simply rotating the energy storage cell 52 to be replaced about its longitudinal axis.

FIGS. 14A, 14B, 14C, 14D show different configurations of the predetermined breaking point 110. While FIG. 14A shows a respective predetermined breaking point 110 formed as a taper for the primary and the redundant contact elements 60, 100, FIGS. 14B, 14C, and 14D illustrate different variations of the predetermined breaking points 110 for each of two primary contact elements 60 with a different number and arrangement of cuts and indentations.

The primary and/or redundant contact element 60, 100 may each comprise a guide geometry 112 for separation at the predetermined breaking point 110. For example, the guide geometry 112 may be formed directly through the outer contour of the contact elements 60, 100. In this way, the separation can be simplified by means of a suitable auxiliary tool, e.g., separating pliers or a lever tool, which is applied to the guide geometry 112. In addition, the guide geometry 112 and/or the processing area 102 may be designed to detect an exchange of the energy storage cell 52 and/or manipulation of the cell connector 56.

Instead of a predetermined breaking point 110, it may alternatively or additionally be provided according to FIGS. 15A, 15B, 15C and 16 to 18 that the primary and/or the redundant contact element 60, 100 has a connection area 114 in order to make it reversibly releasable from the cell connector 56. A reversible release is to be understood to mean that the electromechanical connection between the contact element 60, 100 and the cell connector 56 can be released and restored. Thus, on the one hand, it is possible to release the primary contact element 60 from the cell connector 56 and then reconnect it and, on the other hand, to replace the primary contact element 60 connected to the cell pole 58 of a used energy storage cell 52 with a contact element 100 connected to the cell pole 58 of a replacement energy storage cell 52. Moreover, assembling the energy storage unit 16 may be simplified by pre-assembly of the energy storage cells 52 with the contact elements 60.

In FIG. 15A, the connection area 114 of the contact element 60 is configured as a closed oval eyelet 116. FIG. 15B shows a variant as a single-sided open eyelet 118. Both variants can be connected to the cell connector 56 by means of a screw connection (see FIG. 16) and their oval configuration ensures a certain tolerance compensation in the radial direction of the round cell 50. While the closed eyelet 116 provides a better grip of the contact element 60 during assembly, the open eyelet 118 allows easier assembly by laterally inserting it into the screw connection that has not yet been tightened. In addition, multiple contact elements 60 can be attached to a common connection point of the cell connector 56 in this manner. A connection without tools is shown in FIG. 15C, in which the connection area 114 is configured as a plug-in connection 120 between the contact element 60 and the cell connector 56.

In FIG. 16, the connection areas 114 of the contact elements 60 are embodied as open eyelets 118 according to FIG. 15B. This allows a simple electromechanical connection of the cell poles 58 of the four round cells 50 shown by means of a single screw connection on the cell connector 56. The cell connector 56 can be configured as a punched lattice 122 here, for example, which in turn is electromechanically connected to the printed circuit board 66 of the energy storage unit 16.

FIG. 17 shows an alternative to the exemplary embodiments according to FIGS. 15A, 15B, 15C, and 16, in which the connection area 114 is configured as a flat, bare end of the contact element 60, which is in turn clamped into a cell connector 56 configured as a rail system 124. It is also contemplated that the connection region 114 may have indentations and/or phases debossed in the rail system 124 for easier positioning and/or fixation. Additionally or alternatively, the connection area 114 can also be provided with at least one soldering eye or a material that is easily soldered in order to permanently secure the electrical contact between the contact element 60 and the cell connector 56, against vibrations and shocks in particular, and to ensure a fault-free battery management system (BMS). As is well known, a soldered connection also allows reversible release.

With reference to FIG. 19, the reversible plug-in connection 120 according to FIG. 15C for a cell connector device 76 with a cell connector 56 arranged on both sides of the carrier layer 78 is to be illustrated again. As can be seen, the contact elements 60 are connected at one end in a material-locking and irreversible manner via dimples welded to the cell poles 58 of the energy storage cells 52, while they each have the plug-in connection 120 at their other end. This can be reversibly connected to the cell connector 56 in a simple manner in order to enable an energy storage cell 52 that is no longer usable to be replaced, preferably without tools, together with the contact element 60 connected to it by material-locking.

In FIG. 20, a further exemplary embodiment of the energy storage unit 16 is shown in a highly simplified section along its longitudinal axis L. The cell connector device 76 will not be discussed again here, as it substantially corresponds to the description according to FIGS. 6 to 9. The reversible connection between the cell connector device 76 or the cell connector 56 and the printed circuit board 66 of the energy storage unit 16, for example by means of a spring element 130, a plug-in contact or the like, is essential here. In this way, the printed circuit board 66, along with the electronic unit for the BMS (not shown) arranged on it can be replaced very easily in the event of a defect. Accordingly, it is possible to simply replace the cell connectors 56 or the cell connector devices 76.

It should be pointed out that the exemplary embodiments shown are not limited to FIGS. 1 through 20 or to the shapes, quantities, and size proportions of the individual elements. These are only to be understood as an example.

What is claimed is:

1. An energy storage unit for a one-wheel vehicle or a two-wheel vehicle driven by an electric motor, comprising:
a sub-housing in which at least two cell stacks are housed, the at least two cell stacks arranged adjacent to each other in the sub-housing, each cell stack including at least two electrochemical energy storage cells, the energy storage cells configured as round cells, each energy storage cell including two electrical cell poles;
at least one cell connector configured to electrically conductively connect the electrical cell poles of the at least two energy storage cells in a series and/or parallel circuit; and
a compression device configured to connect the at least one cell connector to the electrical cell poles of the energy storage cells in an assembled state of the energy storage unit in a non-positive force-fit manner,
wherein a tensile force of the compression device is adjustable outside of the sub-housing.

2. The energy storage unit according to claim 1, wherein:
the compression device is configured as at least one rod projecting through the sub-housing with at least one threaded portion attached on an end face, and
the tensile force is adjusted by rotating a nut which is screwed to the threaded portion.

3. The energy storage unit according to claim 1, further comprising:
at least one cell connector device having a carrier layer,
wherein the at least one cell connector is arranged on the carrier layer, such that the compression device presses at least one of the electrical cell poles of the energy storage cells in the assembled state of the energy storage unit against a spring-elastic contact element of the at least one cell connector in a direction of the carrier layer.

4. The energy storage unit according to claim 3, wherein:
the at least one cell connector device is arranged between the at least two cell stacks, and
the at least one cell connector is arranged in each case along a longitudinal axis of the energy storage unit on two opposed end faces of the carrier layer, such that the compression device presses the electrical cell poles of two adjacent energy storage cells of the at least two cell stacks in the assembled state of the energy storage unit in each case against the contact elements of the at least one cell connector in the direction of the carrier layer.

5. The energy storage unit according to claim 4, wherein at least two cell connectors arranged on the end faces of the carrier layer are configured as a conductor plate that encompasses the carrier layer to electrically connect the electrical cell poles of at least a portion of the energy storage cells of the at least two cell stacks together.

6. The energy storage unit according to claim 3, wherein the at least one cell connector device comprises at least one elastic-spring component arranged between the carrier layer and the at least one contact element of the at least one cell connector, such that the compression device presses at least one of the electrical cell poles of the energy storage cell in the assembled state of the energy storage unit against the at least one contact element in the direction of the carrier layer against a spring force, which results from a first spring force of the contact element and a further spring force of the at least one spring component.

7. The energy storage unit according to claim 6, wherein in the assembled state of the energy storage unit, the at least one spring component causes a frictional adhesion contact to the energy storage cell in an area of the electrical cell pole of the energy storage cell.

8. The energy storage unit according to claim 6, wherein the spring component consists of an elastomer, a foam, and/or a synthetic polymer.

9. The energy storage unit according to claim 3, wherein the carrier layer is made of a polyamide or polypropylene.

10. The energy storage unit according to claim 1, wherein:
each cell stack comprises a plurality of hollow cylindrical bores for receiving the energy storage cells, and
a longitudinal gap is along a longitudinal axis of the energy storage unit in each bore, such that at least one spring mounted longitudinal web of a bore adjacent to the longitudinal gap causes a radial fixation of the round cell, and an inner diameter of a bore without the longitudinal web is larger than an outer diameter of the energy storage cell respectively accommodated therein.

11. The energy storage unit according to claim 3, wherein the carrier layer of the cell connector device and the cell stacks each comprise a plurality of positive locking elements to their mutual mechanical connection.

12. A vehicle, comprising:
an electric motor; and
an energy storage unit according to claim 1, the energy storage unit operably connected to the electric motor and releasably connectable to the vehicle or fixedly integrated in the vehicle,
wherein the vehicle has one wheel or the vehicle has two wheels.
